(19) United States
(12) Patent Application Publication
(10) Pub. No.: US 2026/0252279 A1
(43) Pub. Date: Aug. 27, 2026

(54) COMMUNICATION OF POWER PARAMETERS BETWEEN A POWER MANAGEMENT INTEGRATED CIRCUIT AND A MEMORY SYSTEM

(71) Applicant: Micron Technology, Inc., Boise, ID (US)

(72) Inventors: Liang Yu, Boise, ID (US); Jonathan S. Parry, Boise, ID (US); Dustin L. Holloway, Meridian, ID (US)

(21) Appl. No.: 19/540,213

(22) Filed: Feb. 13, 2026

Related U.S. Application Data
(60) Provisional application No. 63/764,506, filed on Feb. 27, 2025.

(51) Int. Cl. G06F 3/06; G06F 1/3225

(52) U.S. Cl. CPC G06F 3/0679; G06F 1/3225

(57) ABSTRACT

Methods, systems, and devices for communication of power parameters between a power management integrated circuit (PMIC) and a memory system are described. According to techniques described herein, a memory system transmit a power request directly to a PMIC. The memory system may transmit the power request in response to one or more parameters satisfying corresponding threshold values, in response to a query from the PMIC, or both. The PMIC may update a power mode of the PMIC and output a power to the memory system according to the power request. The PMIC may transmit a confirmation to the memory system in response to the received request, and the memory system may begin operating in accordance with the requested power in response to receiving the confirmation. In some cases, the memory system may send the power request over an inter-integrated circuit (I2C) channel or one or more pins.

### CROSS REFERENCE

The present Application for Patent claims priority to U.S. Patent Application No. 63/764,506 by Yu et al., entitled “COMMUNICATION OF POWER PARAMETERS BETWEEN A POWER MANAGEMENT INTEGRATED CIRCUIT AND A MEMORY SYSTEM,” filed February 27, 2025, which is assigned to the assignee hereof, and which is expressly incorporated by reference in its entirety herein.

### TECHNICAL FIELD

The following relates to one or more systems for memory, including communication of power parameters between a power management integrated circuit (PMIC) and a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports communication of power parameters between a power management integrated circuit (PMIC) and a memory system in accordance with examples as disclosed herein.

FIG. 2 shows an example of a system that supports communication of power parameters between a PMIC and a memory system in accordance with examples as disclosed herein.

FIG. 3 shows an example of a flowchart that supports communication of power parameters between a PMIC and a memory system in accordance with examples as disclosed herein.

FIG. 4 shows an example of a block diagram of a memory system that supports communication of power parameters between a PMIC and a memory system in accordance with examples as disclosed herein.

FIG. 5 shows an example of a flowchart illustrating a method or methods that support communication of power parameters between a PMIC and a memory system in accordance with examples as disclosed herein.

### DETAILED DESCRIPTION

In some systems, a power management integrated circuit (PMIC) (e.g., a power management circuit), may manage a power (e.g., a voltage, a current, both) supplied to a memory system including one or more memory devices in accordance with input from a host system, which may be referred to as a system on a chip (SOC) in some examples herein. For example, the PMIC may operate according to one or more power modes (e.g., a pulse width modulation (PWM) mode, a phase frequency modulation (PFM) mode, or some other power mode), where different power modes may be associated with varying levels of performance at the memory system for different power levels. The PMIC may switch between power modes and provide different amounts of power to the memory system at different times according to host system estimations (e.g., predictions) of power usage by the memory system. In some cases, the estimations of the host system may inaccurately represent upcoming power usage at the memory system. Such inaccurate power usage information may cause the PMIC to switch to a power mode or to supply a power to the memory system that is less efficient than a power mode of the PMIC if the PMIC is given accurate power usage information, resulting in reduced processing capacity, increased latency, leaked power (e.g., wasted power) in the system, or any combination thereof. Thus, techniques for more accurately indicating memory system power usage to a PMIC may reduce leaked power and latency while increasing a reliability and processing capacity of the memory system, among other examples.

According to techniques described herein, the memory system may transmit a power request (e.g., indicating future or upcoming power usage or power draw) directly to the PMIC, where the power request may indicate a requested voltage, a requested current, or both. In some cases, the memory system may transmit the power request to the PMIC in response to monitoring one or more parameters of the memory system and determining that one or more of the parameters satisfy one or more corresponding threshold values. For example, the one or more parameters may indicate a power usage for the memory system and a power mode suited to operations at the memory system. Additionally, or alternatively, the memory system may transmit the power request to the PMIC in response to receiving a query from the PMIC. The PMIC may update a power mode and output a power (e.g., a voltage, a current) of the PMIC in response to the received request. In some cases, the PMIC may transmit a confirmation message to the memory system in response to the received request, and the memory system may begin operating according to the updated power mode and power in response to receiving the confirmation. In some cases, the memory system may transmit the power request via a first channel that may be different from a second channel (e.g., a physical layer channel) between the memory system and the host system. For example, the first channel may include an universal flash system (UFS) channel, one or more pins, or both. Accordingly, the PMIC may receive more accurate power usage information associated with the memory system, the PMIC may provide power to the memory system more efficiently (e.g., with less latency and wasted power), and the memory system may experience increased processing capability and reduced latency in response to receiving sufficient and accurate power.

In addition to applicability in memory systems as described herein, techniques for communication of power parameters between a power management integrated circuit and a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by enabling direct communication between the memory system and a PMIC, which may enable power mode switching in direct response to memory system conditions, decreasing power inefficiencies at the memory system, among other benefits.

Features of the disclosure are illustrated and described in the context of systems, devices, and circuits. Features of the disclosure are further illustrated and described in the context of flowcharts.

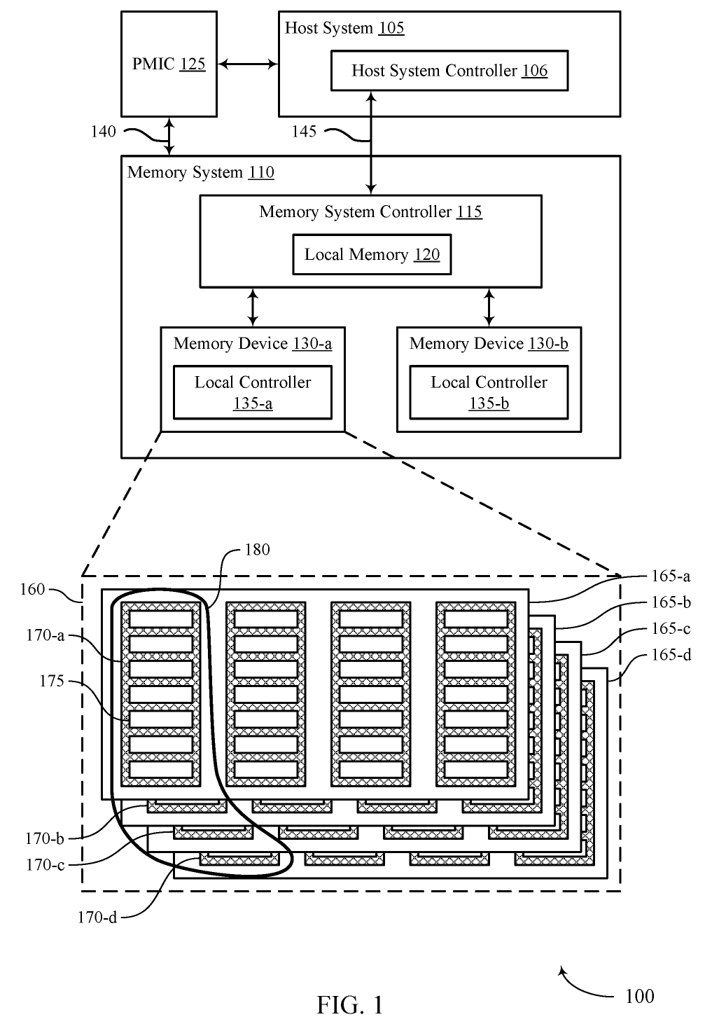

FIG. 1 shows an example of a system 100 that supports communication of power parameters between a PMIC and a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an ASIC, a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

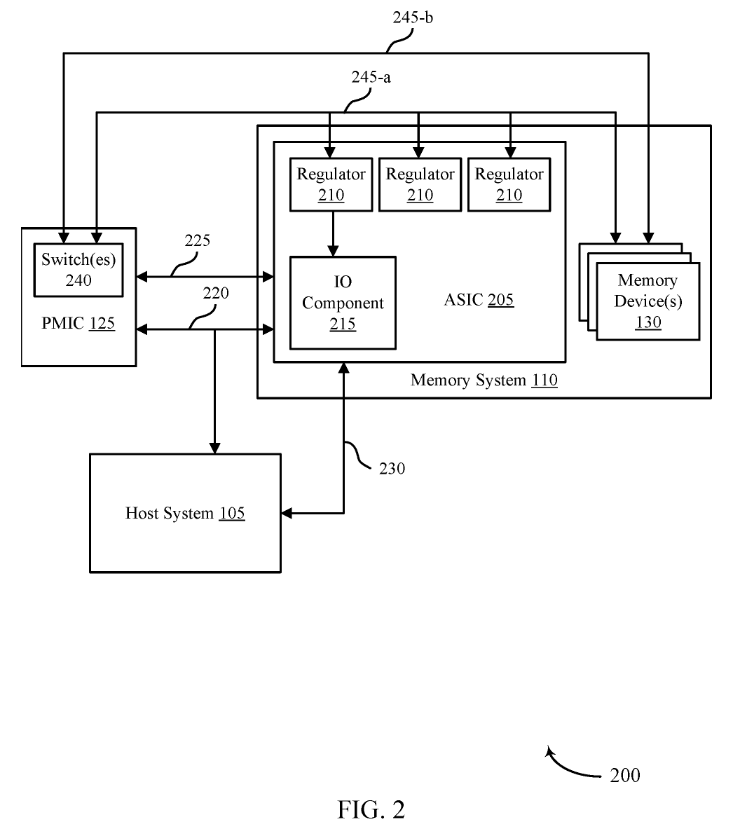

In some cases, the system 100 may include a PMIC 125. In some aspects, the PMIC 125 may be configured to manage the power (e.g., voltage, current, or both) provided to one or more portions of the memory system 110 (e.g., a UFS memory system), including the memory devices 130. For example, the PMIC 125 may be coupled with a power input, may include logic circuitry for determining power to output to the memory system 110, and may include one or more switches (e.g., such as low dropout (LDO) switches) to output various powers to the memory system 110. In some cases, the PMIC may be capable of outputting power via one or more power rails and according to one or more power modes (e.g., as described herein with respect to FIG. 2).

In some examples, vendors and designers of the memory system 110 and the PMIC 125 may have alignment (e.g., via standards) regarding a maximum transient current load, such that the PMIC 125 may be designed properly with adequate bulk/decoupling capacitors on the mobile board. However, some memory systems 110 may be implemented in devices having different PCB design constraints, power limits, resistance, or the like, such that an actual maximum current supported by the memory system 110 may vary based on the use case and overall device/system functionality. Additionally, or alternatively, some memory systems 110 may support some corner cases in which overcurrent may be beneficial, or some PMICs 125 may support corner cases (e.g., overheat) in which reduced transient load is beneficial to maintain or improve power delivery performance and quality without increase voltage droop and/or noise. In some other examples, if the memory system 110 experiences power noise (e.g., not proper functioning), the memory system 110 may benefit from dynamically reducing a current load. In some other examples, the PMIC 125 may detect an input supply droop (e.g., due to too much load current at the memory system 110), but the memory system 110 may not see the droop on its voltage rails and may not take any actions. The impedance and corresponding voltage droop experienced by the memory system 110 may be based on a frequency bandwidth of the load current, such that, for example, a one ampere (A) current load may produce different voltage droops at different frequencies. Accordingly, the host system 105, the PMIC 125, or both as described herein may include a power delivery network (PDN) voltage droop detector that may detect voltage droop and communicate the voltage droop information, current calculated based on PDN loss, or both to the memory system 110, which may improve coordination and performance relative to a maximum current communication via a communication protocol.

In some cases, the PMIC 125 may operate according to one or more power modes, such as a PWM mode, a PFM mode, or other modes, where different power modes may be associated with improved performance at the memory system 110 for different power levels. In some cases, the PMIC 125 may switch between power modes and provide different power to the memory system 110 according to estimations (e.g., predictions) made by the host system 105 of power usage at the memory system 110. In some cases, the estimations may inaccurately represent upcoming power usage at the memory system 110. Such inaccurate power usage information may cause the PMIC 125 to switch to a power mode or supply a power to the memory system 110 that is less efficient than it may have been with accurate power usage information, resulting in reduced processing capacity, increased latency, and/or leaked power (e.g., wasted power) in the system. Thus, techniques for more accurately indicating power usage at the memory system 110 to a PMIC 125 may reduce leaked power and latency while increasing a reliability and processing capacity of the memory system 110.

According to techniques described herein, the memory system 110 may transmit a power request (e.g., indicating future or upcoming power usage or power draw) directly to the PMIC 125, where the power request may indicate a requested voltage, a requested current, or both. In some cases, and the memory system 110 may transmit the power request in response to monitoring one or more parameters associated with the memory system 110 and determining that one or more of the parameters satisfy one or more corresponding threshold values. For example, the one or more parameters may indicate a power usage a power mode suited to operations at the memory system 110. Additionally, or alternatively, the memory system 110 may transmit the power request to the PMIC 125 in response to receiving a query from the PMIC 125. The PMIC 125 may update a power mode and output a power (e.g., a voltage, a current) of the PMIC 125 in response to the received request. In some cases, the PMIC 125 may transmit a confirmation message to the memory system 110 in response to the received request, and the memory system 110 may begin operating according to the updated power mode and updated power in response to receiving the confirmation. In some cases, the memory system 110 may transmit the power request via a first channel 140 that may be different from a second channel 145 (e.g., a physical layer channel) between the memory system 110 and the host system 105. For example, the first channel may include an inter-integrated circuit (I2C) channel, one or more pins, or both, where the I2C channel may also be coupled with the host system 105. Accordingly, the PMIC 125 may receive more accurate power usage information associated with the memory system 110, the PMIC 125 may provide power to the memory system 110 more efficiently (e.g., with less latency and wasted power), and the memory system 110 may experience increased processing capability and reduced latency in response to receiving sufficient and accurate power.

The system 100 may include any quantity of non-transitory computer readable media that support communication of power parameters between a PMIC and a memory system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

FIG. 2 shows an example of a system 200 that supports communication of power parameters between a PMIC and a memory system in accordance with examples as disclosed herein. In some cases, aspects of the system 200 may implement or be implemented by aspects of FIG. 1. For example, the system 200 may include the memory system 110, the host system 105, the PMIC 125, and one or more of the memory devices 130, as described herein with respect to FIG. 1. Additionally, the system 200 may include one or more power rails 245 between the PMIC 125 and the memory system 110, a first channel between at least the PMIC 125 and the memory system 110 (e.g., including one or more of a I2C channel 220 and one or more pins 225, such as the first channel 140 as described with respect to FIG. 1), and a second channel between the host system 105 and the memory system 110 (e.g., such as the second channel 145, as described with respect to FIG. 1). In some aspects, the memory system 110 may communicate directly with the PMIC 125 via the first channel to request power changes (e.g., voltage changes, current changes) from the PMIC 125 on the power rails 245.

The PMIC 125 may operate in (e.g., use) one or more power modes to provide power to the memory system 110 (e.g., as described with respect to FIG. 1). In some cases, the PMIC 125 may operate in a PWM mode to maintain a relatively high power efficiency for relatively heavy current load at the memory system 110. A power efficiency may indicate a proportion of supplied power, of the total supplied power, that is used for useful operations at the memory systems 110 (e.g., processing, communicating), where some of the supplied power may leak or be turned into heat instead. If the memory system 110 is using relatively small amounts of current (e.g., a low current draw), and the PMIC 125 operates in the PWN mode, this may reduce efficiency. Additionally, or alternatively, the PMIC 125 may operate in a PFM mode to maintain higher power efficiency in a power saving mode of the memory system 110 or to accommodate relatively light current load conditions at the memory system 110. For example, if the memory system 110 is using less current, the PFM mode may increase an efficiency of the PMIC 125 and reduce a power leakage at the PMIC 125 or the memory system 110. In some cases, the PMIC 125 may support a dynamic voltage scale (DVS) mode in conjunction with the PFM mode or in a standalone fashion, and the memory system 110 may benefit from receiving lower power levels (e.g., lower voltage) as part of the DVS mode at the PMIC 125. For example, use of the DVS mode may reduce power leakage at the memory system 110 during a sleep mode or a high speed mode (e.g., high speed gear mode 1 (HS Gx1)).

In some cases, the PMIC 125 may determine and select one or more power modes to use according to loads and power usage at the memory system 110. For example, the PMIC 125 may determine or be configured with one or more thresholds for switching between the power modes, which may be threshold voltages or currents (e.g., from 50 milli Amps (mAs) to 300 mAs, among other examples). In some cases, the host system 105 (e.g., an SOC) may transmit control signaling to the PMIC 125 (e.g., via I2C protocols, using an I2C interface of the PMIC 125) that indicates estimated loads or power usage (e.g., future power usage) for the memory system 110, which the PMIC 125 may compare to the one or more thresholds to determine a power mode to use. However, the estimated power usage from the host system 105 may be inaccurate, and may cause the PMIC 125 to use a less efficient mode or to not switch modes even though another power mode may be more efficient. That is, the PMIC 125 may operate in a power mode associated with more power leakage (e.g., from the PMIC 125, from the memory system 110) than another power mode because of inaccurate power usage information for the memory system 110 from the host system 105. In some cases, such leakage due to power information inaccuracies may increase as power usage or loads at the memory system 110 increase.

In some cases, the host system 105 may transmit the power usage estimations to the PMIC 125 via the I2C channel 220, and the I2C protocols used in the I2C channel 220 may allow more systems (e.g., or devices, in addition to the host system 105) to join as either controlling systems (e.g., masters) or secondary devices. For example, I2C protocols may allow additional systems, such as the memory system 110, to request, read, or write configurations from other systems coupled with the I2C channel 220. In some cases, such requests, reads, or writes may be performed in accordance with an address map for the I2C protocol, where each system may be associated with an I2C address. Additionally, or alternatively, communication via the I2C channel 220 may include each participating system performing a priority arbitration procedure in accordance with pull down schemes (e.g., open drain circuits) for the I2C channel 220 (e.g., including a serial clock pin (SCL), a serial data pin (SDA), or both) to coordinate communication.

According to techniques described herein, the memory system 110 (e.g., a UFS device or system) may directly communicate (e.g., using an I2C protocol) with the PMIC 125 to indicate power usage or loads (e.g., UFS power request for power rails 245). For example, the memory system 110 may transmit a power request to the PMIC 125 in response to a power usage or power status change at the memory system 110, which may be detected by monitoring one or more parameters associated with the memory system 110 that may indicate a power mode for supplying the power from the PMIC 125. In some cases, the memory system 110 may transmit the power request to the PMIC 125 via the I2C channel 220, one or more pins 225 (e.g., one or more UFS general-purpose input/output (GPIO) communication pins, one or more open drain bus communication pins), or both. The power request may indicate one or more requested powers, voltages, currents, or both to be supplied over the power rails 245.

In some cases, the memory system 110 may communicate with the PMIC 125 via a first channel. For example, the ASIC 205 of the memory system 110 or an input/output (IO) component 215 of the ASIC 205 (e.g., such as an I2C component, a GPIO component, an open drain component) may be coupled with the first channel, and the first channel may be coupled with the PMIC 125, such that the memory system 110 may transmit the power request to the PMIC 125 via the first channel. The first channel may include the I2C channel 220, the one or more pins 225 (e.g., one or more GPIO pins, one or more open drain source pins), or both, or the one or more pins 225 may be part of the I2C channel 220. In some cases, the first channel may be separate from a second channel for communication of data (e.g., read data, write data) between the memory system 110 and the host system 105, such as a physical layer channel 230.

In some cases, the first channel may include at least a serial clock pin (SCL) and a serial data pin (SDA) to use the I2C protocol. In some cases, a set of pins of the memory system 110 (e.g., such as part of the IO component 215) may include one or more pins that are reserved for future use (RFU) (e.g., RFU balls, RFU pins). In some cases, one or more of the RFU pins may be utilized as the SCL and SDA to perform the I2C communications as the first channel or as part of the first channel. Additionally, or alternatively, the pins may include vendor specific function (VSF) pins, which may be utilized as the SCL and SDA.

In some cases, the memory system 110 may monitor one or more parameters associated with the memory system 110 and compare a monitored value of the one or more parameters to one or more threshold values. The memory system 110 may determine whether to transmit the power request to the PMIC 125 according to the comparison. For example, if one parameter, a combination of the parameters, or a threshold quantity of the parameters satisfy (e.g., are above, below, or equal to) a corresponding threshold value, the memory system 110 may transmit the power request to the PMIC 125. In some cases, the one or more parameters may include a thermal parameter associated with the memory system 110 (e.g., a temperature of the memory system 110, of the ASIC 205, or both), a data transfer rate parameter associated with the memory system 110 (e.g., a high speed gear (HS Gx) parameter), a current draw parameter associated with the memory system 110 (e.g., a switch on or off (SOF) core current draw associated with the LDO being dynamically on or off during active or idle/sleep states to save power), a low power mode parameter associated with the memory system 110 (e.g., entry or existence of a sleep mode or level 2 (LV2) (e.g., standby mode)), or any combination thereof. Accordingly, the threshold values may include a threshold temperature, a threshold data transfer rate, a threshold current draw, a threshold power mode (e.g., whether the memory system 110 has entered the low power mode, where entering the threshold power mode or any power mode requesting less power than the threshold power mode satisfies the threshold power mode), or any combination thereof.

In some cases, the PMIC 125 may transmit (e.g., and the memory system 110, the ASIC 205, or the IO component 215 may receive) a query via for the power request via the first channel. For example, the query may request that the memory system 110 transmit the power request to the PMIC 125. In some cases, the PMIC 125 may transmit the query in response to detecting a change associated with the memory system 110 (e.g., such as an increased current load or power leakage), detecting a change associated with the PMIC 125 (e.g., PMIC temperature surpassing a threshold temperature, PMIC overheating), or as a periodic query. Additionally, or alternatively, the query may include a request, such as requesting that the memory system 110 request a reduced power (e.g., power throttle, if the PMIC 125 is overheating). In some cases, the memory system 110 may transmit the power request in response to the query, in response to one or more parameters satisfying the one or more threshold values, or a combination thereof. For example, the memory system 110 may transmit the power request in response to the query if one or more parameters are also satisfying one or more of the threshold values.

In some cases, the memory system 110 may participate in the I2C protocol and transmit the power request according to the I2C protocol by using an I2C local address assigned to the memory system 110. For example, the memory system 110 may be associated with a predefined (e.g., fixed) address, which may be indicated in a datasheet or other document associated with the memory system 110. Additionally, or alternatively, the host system 105 may assign (e.g., write) a new I2C address to the memory system 110 (e.g., in the case the I2C address for the memory system 110 is lost after a power off, for example, of the power rail 245-b). In some cases, the I2C address may be determined by a fuse configuration in a ROM associated with the memory system 110. Additionally, or alternatively, the I2C address of the memory system may be configured via pin bias configurations at the memory system 110, such as through UFS package balls (e.g., which may allow a host system 105 or user of the system 200, such as in an example of a mobile device, to configure the I2C address for the memory system 110). Additionally, or alternatively, the I2C address may be defined via a pin bias associated with a package around the memory system 110 (e.g., a package configurations of the memory system 110).

The power request may include signaling that is associated with (e.g., supported by) a format or protocol of the first channel. For example, if the first channel includes the I2C channel 220, the power request may be an I2C message that includes one or more bits to indicate the requested power. Additionally, or alternatively, if the memory system 110 transmits the power request via the one or more pins 225, the power request may include the I2C message, or may include a high or low signal. For example, if the one or more pins 225 includes a single pin (e.g., only a single pin), the power request may include a high signal (e.g., a “1”) or a low signal (e.g., a “0”) from the single pin, where one of the signals (e.g., the high signal) may request a default configuration (e.g., a default power or power mode) from the PMIC 125 (e.g., such as a PWM mode), and the other signal (e.g., the low signal) may request another configuration from the PMIC 125 (e.g., such as the PFM mode, a DVS mode, or both, and a range of voltages).

In response to receiving the power request, the PMIC 125 may determine a power to output (e.g., an output power, including an output voltage, an output current, or both) in response to the power request. In some cases, the output power may be the requested power or another achievable power at the PMIC 125. For example, the PMIC 125 may determine whether the requested power is achievable according to power modes and power outputs that the PMIC 125 can produce. If the request power is not achievable, the PMIC 125 may determine a power mode to enter (e.g., or remain in) in accordance with the power request, and may determine an output power (e.g., or one or more output powers for the power rails 245) that is achievable (e.g., and within a threshold power range from the requested power). Alternatively, if the requested power is achievable, the PMIC may determine a power mode to enter (e.g., or remain in) to output the requested power. The PMIC may enter the determined power mode and begin outputting the output power to the power rails 245. In some cases, one or more parameters of the host system 105 may also affect the determination of the power mode and output power by the PMIC 125. For example, the host system 105 may indicate one or more allowed power modes or power ranges for the PMIC 125.

In some cases, the memory system 110 may receive a confirmation message from the PMIC 125 in response to the power request. The confirmation message may indicate, to the memory system 110, whether the PMIC 125 is capable of outputting the requested power (e.g., whether the requested power is achievable), that the PMIC 125 has or will output the requested power, the determined output power, or any combination thereof. The PMIC 125 may transmit the confirmation message to the memory system 110 (e.g., to the ASIC 205, to the IO component 215) via the first channel. In some cases, in response to receiving the confirmation message, the memory system 110 may begin operating in accordance with the determined power mode using the output power from the PMIC 125.

In some cases, the memory system 110 may begin operating in accordance with the power mode using the output power without receiving the confirmation message. In some cases, the memory system 110 may begin using the output power immediately after transmitting the power request, or a configured duration after transmitting the power request. For example, the host system 105 may configure a duration after transmitting the power request for the memory system 110 to wait to begin operating according to the power mode using the output power from the PMIC 125, which may allow the PMIC to determine the power mode and the output power, and may allow time for the switches 240 to adjust the output power on the power rails 245.

In some cases, the memory system 110 may include one or more power rails 245. For example, a power rail 245-a (e.g., a VCC line) may provide power from the PMIC 125 to the regulators 210, one or more portions of the memory devices 130 of the memory system 110, or both. Additionally, or alternatively, a power rail 245-b (e.g., a VCCQ line) may provide power from the PMIC 125 to one or more portions of the memory devices 130. In some cases, the output power supplied by the PMIC 125 to the power rail 245-a may be different than or the same as the power supplied by the PMIC 125 to the power rail 245-b. For example, the switch(es) 240 of the PMIC 125 (e.g., UFS power LDO regulators) may control the output power(s) for the one or more power rails 245 such that the power rails 245 may convey different output powers to the memory system 110.

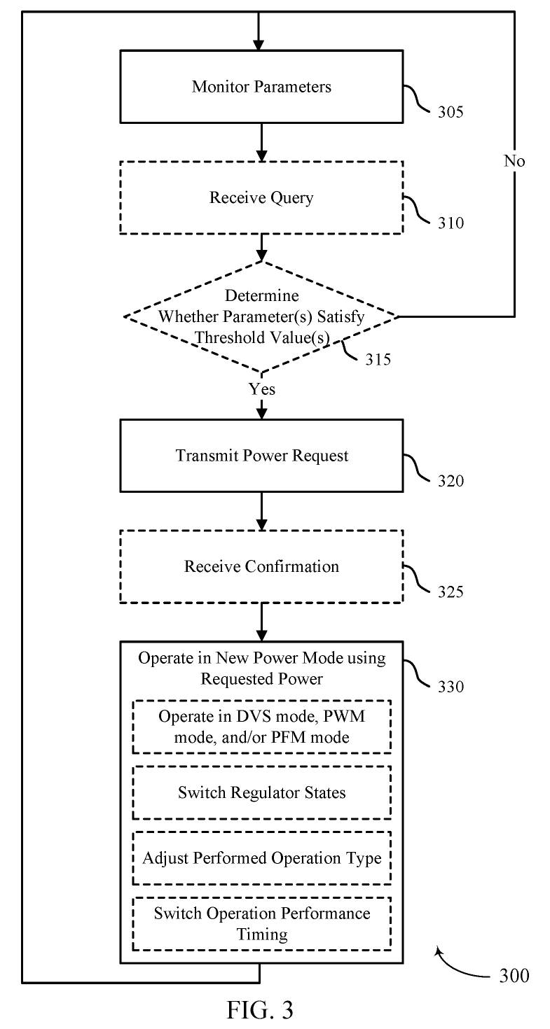

To operate the memory system 110 according to the power mode determined at the PMIC 125, and to use the output power from the PMIC 125, the memory system 110 may perform one or more operations. For example, operating in accordance with the power mode may include operating in accordance with the DVS mode, the PWM mode, the PFM mode, or any combination thereof. For example, one or more regulators or components of the memory devices 130 may adjust operation to accept power in a power form (e.g., waveform) associated with the power mode. For example, the memory system 110 may include one or more regulators 210, where one or more of the regulators 210 may include an “always on” (Aon) LDO regulator (e.g., which receives power while the PMIC is outputting power) coupled with the IO component 215, an SOF LDO regulator, a mobile industry processor interface (MIPI) physical layer (MPHY) protocol regulator, other regulators, or any combination thereof. Additionally, or alternatively, operating in the power mode using the output power may include switching a state of the one or more regulators 210 to accommodate the power mode, the output power, or both. Additionally, or alternatively, operating in the power mode using the output power may include adjusting a type of operation performed at the memory system 110 in accordance with the output power. For example, the memory system 110 may perform operations that use less power (e.g., read operations) if the output power is relatively low, and may perform operations that use relatively more power (e.g., write operations, garbage collection) if the output power is relatively high. Additionally, or alternatively, to operate in the power mode using the output power, the memory system may switch a timing for performance of one or more operations at the memory system 110. For example, the memory system 110 may delay or otherwise slow down operations at the memory system 110 if the output power is relatively low, and may hasten (e.g., expedite) or otherwise increase the speed of operations at the memory system 110 if the output power is relatively high. The memory system 110 may begin monitoring the one or more parameters again with the same or updated threshold values and request an updated power in a cyclic manner, as described with respect to FIG. 3.

In some examples, the PMIC 125, the memory system 110, or both may include a voltage droop detector, which may be some component (e.g., circuitry) configured to detect a drop or irregularity in the supply voltage provided to the memory system 110 (e.g., to detect any PDN issues or irregularities). The voltage droop detector may set some value or flag when a voltage droop above a certain threshold is detected. In some examples, the PMIC 125 may directly notify the memory system 110 (e.g., via the I2C channel 220 and/or the one or more pins 225) to perform PDN control or load current throttling in response to the voltage droop indication. In some examples, the PMIC 125 may send updated maximum allowable current information to the memory system 110 and/or the host system 105 based on the voltage droop. Additionally, or alternatively, the PMIC 125 may send the voltage droop information directly to the memory system 110 and/or the host system 105, and the memory system 110, the host system 105, or both may compare the voltage droop to a threshold or expected voltage droop (e.g., configured for the memory system 110) to determine (e.g., using a function or lookup table) how much current should be throttled based on the voltage droop. If the PMIC 125 sends the voltage droop information and/or maximum allowable current information directly to the memory system 110, the PMIC 125 may monitor for feedback. An acknowledgement may indicate that the PDN adjustment is complete, and a negative acknowledgement or no response may indicate an error, and the PMIC 125 may notify the host system 105 of a power hardware error.

In some examples, the host system 105 may real-time detect PDN attributes (e.g., PDN statistics or information) from any source, including the PMIC 125, the memory system 110, or both, and may convey this information to the memory system 110 (e.g., a UFS storage device). The information may be conveyed using one or more communication protocols via the physical layer channel 230 or some other channel or pins. The memory system 110 (e.g., the UFS storage device) may dynamically react to the information by, for example, throttling a maximum current, or performing other PDN actions to adjust according to the information.

FIG. 3 shows an example of a flowchart 300 that supports communication of power parameters between a PMIC and a memory system in accordance with examples as disclosed herein. In some cases, aspects of the flowchart 300 may implement or be implemented by aspects of FIGS. 1 and 2. For example, the flowchart 300 may include operations performed by a memory system 110, as described herein with respect to FIGS. 1 and 2. In some cases, the flowchart 300 may illustrate a memory system 110 transmitting a power request to a PMIC (e.g., such as the PMIC 125 described with respect to FIGS. 1 and 2) and operating according to the power outputted from the PMIC in response to the power request.

In the following description of flowchart 300, the operations may be performed in a different order than the order shown, or other operations may be added or removed from the flowchart 300. For example, some operations may be left out of flowchart 300, may be performed in different orders or at different times, or other operations may be added to flowchart 300. A memory system (e.g., such as the memory system 110) may perform the operations of flowchart 300, and/or some aspects of some operations may also be performed by one or more other devices, such as the host system 105, the host system controller 106, the PMIC 125, a memory device 130, or any combination thereof. In some cases, the steps in flowchart 300 may be implemented in instructions or firmware stored on memory of a memory system 110 (e.g., memory devices 130) and executed by the memory system controller 115 (and/or local controller 135). For example, the instructions, when executed by one or more controllers (e.g., the memory system controller 115, the local controllers 135, the ASIC 205), may cause the one or more controllers (e.g., or the memory system 110) to perform the operations of the flowchart 300.

At 305, one or more parameters may be monitored. For example, the memory system may monitor the one or more parameters while operating in accordance with a first power (e.g., a first voltage and a first current) supplied to the memory system by a PMIC. In some cases, a memory system controller 115 or a local controller 135 of the memory system may monitor the one or more parameters. In some cases, the one or more parameters may be indicative of a power mode of the memory system. For example, the one or more parameters may include a temperature parameter associated with the memory system, a data transfer rate parameter associated with the memory system, a current draw parameter associated with the memory system, a low power mode parameter associated with the memory system, or any combination thereof.

At 310, in some examples, a query associated with the power management circuit may be received. For example, the memory system may receive the query from the PMIC. In some cases, the memory system controller 115, the local controller 135, or other interface circuitry (e.g., the ASIC 205 or IO component 215) of the memory system may receive the query. In some cases, the query may be a request from the PMIC for power information (e.g., the power request) from the memory system.

At 315, whether the one or more parameters satisfy one or more respective threshold values may be determined. For example, the memory system may determine whether the one or more parameters satisfy the one or more threshold values in response to monitoring the one or more parameters (e.g., monitoring the one or more values of the parameters). For example, the memory system controller 115 or another logical component of the memory system may determine if one or more of the parameters satisfy one or more threshold values. In some cases, the one or more threshold values may be configured at the memory system by a host system, dynamically determined by the memory system, or preconfigured at the memory system. If the one or more parameters do not satisfy the one or more threshold values, the memory system may return to 305. If one or more parameters do satisfy the one or more threshold values, the memory system may continue to 320.

At 320, a power request may be outputted. For example, the memory system may output the power request to the PMIC via a first channel. In some cases, the memory system controller 115, the local controller 135, or other interface circuitry of the memory system may output the request. In some cases, the power request may indicate a second voltage, a second current, or both associated with the power mode indicated by the one or more parameters. In some cases, the memory system may output the power request in response to at least one parameter of the one or more parameters satisfying a respective threshold value of the one or more threshold values (e.g., at 315), in response to receiving the query from the PMIC (e.g., at 310), or both.

In some cases, the first channel may be different than a physical layer channel (e.g., a second channel) for communication of data from the memory system to the host system, and may include one or more types of channels (e.g., as described with respect to the I2C channel 220 and the one or more pins 225 of FIG. 2). For example, the first channel may include one or more pins (e.g., one or more GPIO pins, one or more open drain buses, such as the one or more pins 225) associated with outputting the power request. In such an example, outputting the power request may include setting the one or more pins to a first value that indicates the requested power. Additionally, or alternatively, the first channel may include an I2C communication channel between the memory system and the PMIC, such as the I2C channel 220 (e.g., I2C bus).

At 325, a confirmation message (e.g., confirmation signaling) may be received. For example, the memory system may receive the confirmation message from the PMIC in response to the power request. In some cases, the memory system controller 115, the local controller 135, or other interface circuitry of the memory system may receive the confirmation message from the PMIC. In some cases, the confirmation message may indicate that an output power (e.g., an output voltage, an output current, or both) is, has been, or will be outputted form the PMIC in response to the power request. In some cases, the output power supplied by the PMIC may be the requested power or another power determined by the PMIC in response to the requested power (e.g., as described herein with respect to FIG. 2). For example, the memory system may operate in the power mode using the updated power (e.g., the second voltage, the second current, or both, or another voltage, current, or both) in response to the confirmation message. In some cases, the confirmation message may also be in accordance with one or more operational parameters associated with the host system (e.g., an SOC), such as an operation parameter set to enable confirmation messages between the PMIC and the memory system.

At 330, operations according to the power mode (e.g., the new or requested power mode) may be performed. For example, the memory system may operate in the power mode using the updated power supplied to the memory system by the PMIC. In some cases, the memory system controller 115 or the local controller 135 may operate the memory system according to the power mode.

Operating according to the power mode may include one or more operations. For example, to operate according to the power mode using the updated power, the memory system may operate in accordance with a DVS mode, a PWM mode, a PFM mode, or any combination thereof (e.g., one or more power modes of the PMIC) in accordance with the power request. Additionally, or alternatively, to operate according to the power mode using the updated power, the memory system may switch a state of one or more regulators (e.g., regulators 210 as described with respect to FIG. 2) of the memory system in accordance with the updated power. Additionally, or alternatively, to operate according to the power mode using the updated power, the memory system may adjust a type of operation performed at the memory system in accordance with the updated power. Additionally, or alternatively, to operate in the power mode using the updated power, the memory system may switch a timing for performance of one or more operations at the memory system in accordance with the updated power.

The memory system may return to monitoring the one or more parameters (e.g., at 305) while operating in the power mode using the output power. For example, the memory system may monitor the one or more parameters to determine if the one or more parameters satisfy one or more second threshold values, to determine if the one or more parameters fail to satisfy the one or more threshold values, or both, and may repeat one or more of steps 310 through 330 in response to such occurrences.

According to the techniques described with respect to the flowchart 300, a memory system may communicate directly with a PMIC to adjust a power mode and output power (e.g., voltage, current, or both). In some cases, such direct communications may increase an efficiency of the system (e.g., of the PMIC, of the memory system, of the host system, or any combination thereof), such as by reducing leaked power, reducing latency due to receiving insufficient power, and increasing processing capabilities due to receiving sufficient power.

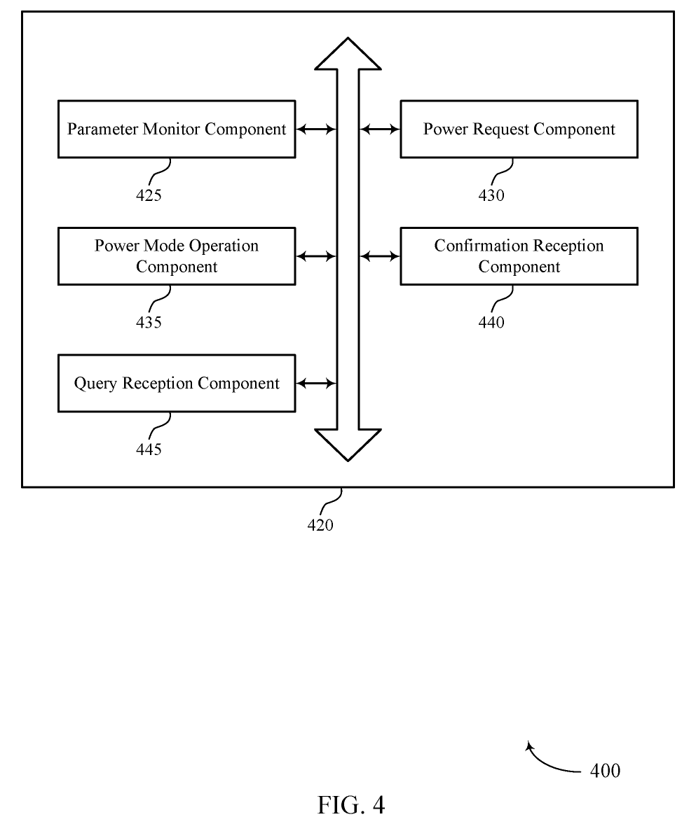

FIG. 4 shows a block diagram 400 of a memory system 420 that supports communication of power parameters between a PMIC and a memory system in accordance with examples as disclosed herein. The memory system 420 may be an example of aspects of a memory system as described with reference to FIGS. 1 through 3. The memory system 420, or various components thereof, may be an example of means for performing various aspects of communication of power parameters between a PMIC and a memory system as described herein. For example, the memory system 420 may include a parameter monitor component 425, a power request component 430, a power mode operation component 435, a confirmation reception component 440, a query reception component 445, or any combination thereof. Each of these components, or components of subcomponents thereof (e.g., one or more processors, one or more memories), may communicate, directly or indirectly, with one another (e.g., via one or more buses).

The memory system 420 may support memory operations in accordance with examples as disclosed herein. The parameter monitor component 425 may be configured as or otherwise support a means for monitoring one or more parameters while operating the memory system in accordance with a first voltage and a first current supplied to the memory system by a power management circuit, where the one or more parameters are indicative of a power mode of the memory system. The power request component 430 may be configured as or otherwise support a means for outputting, to the power management circuit via a first channel and in response to the one or more parameters satisfying one or more threshold values, a request that indicates a second voltage, a second current, or both associated with the power mode, where the first channel is different than a second channel for communication of data from the memory system to a host system. The power mode operation component 435 may be configured as or otherwise support a means for operating in the power mode using the second voltage, the second current, or both supplied to the memory system by the power management circuit in response to outputting the request.

In some examples, the confirmation reception component 440 may be configured as or otherwise support a means for receiving a confirmation message that indicates an output voltage, an output current, or both, supplied by the power management circuit is adjusted in response to the request, where the memory system operates in the power mode using the second voltage, the second current, or both further in response to the confirmation message.

In some examples, the confirmation message is in accordance with the request and one or more operational parameters associated with the host system.

In some examples, the query reception component 445 may be configured as or otherwise support a means for receiving a query associated with the power management circuit, where the request that indicates the second voltage, the second current, or both is output further in response to the query.

In some examples, the one or more parameters include a temperature parameter associated with the memory system, a data transfer rate parameter associated with the memory system, a current draw parameter associated with the memory system, a low power mode parameter associated with the memory system, or any combination thereof.

In some examples, to support operating in the power mode using the second voltage, the second current, or both, the power mode operation component 435 may be configured as or otherwise support a means for operating in accordance with a dynamic voltage scale mode, a pulse width modulation mode, a phase frequency modulation mode, or any combination thereof in accordance with the request indicating the second voltage, the second current, or both.

In some examples, to support operating in the power mode using the second voltage, the second current, or both, the power mode operation component 435 may be configured as or otherwise support a means for switching a state of one or more regulators of the memory system in accordance with the second voltage, the second current, or both.

In some examples, to support operating in the power mode using the second voltage, the second current, or both, the power mode operation component 435 may be configured as or otherwise support a means for adjusting a type of operation performed at the memory system in accordance with the second voltage, the second current, or both.

In some examples, to support operating in the power mode using the second voltage, the second current, or both, the power mode operation component 435 may be configured as or otherwise support a means for switching a timing for performance of one or more operations at the memory system in accordance with the second voltage, the second current, or both.

In some examples, the first channel includes one or more pins associated with outputting the request that indicates the second voltage, the second current, or both. In some examples, the second channel includes a physical layer channel.

In some examples, to support outputting the request that indicates the second voltage, the second current, or both, the power request component 430 may be configured as or otherwise support a means for setting the one or more pins to a first value that indicates the second voltage, the second current, or both.

In some examples, the first channel includes an inter-integrated circuit communication channel between the memory system and the power management circuit. In some examples, the second channel includes a physical layer channel.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

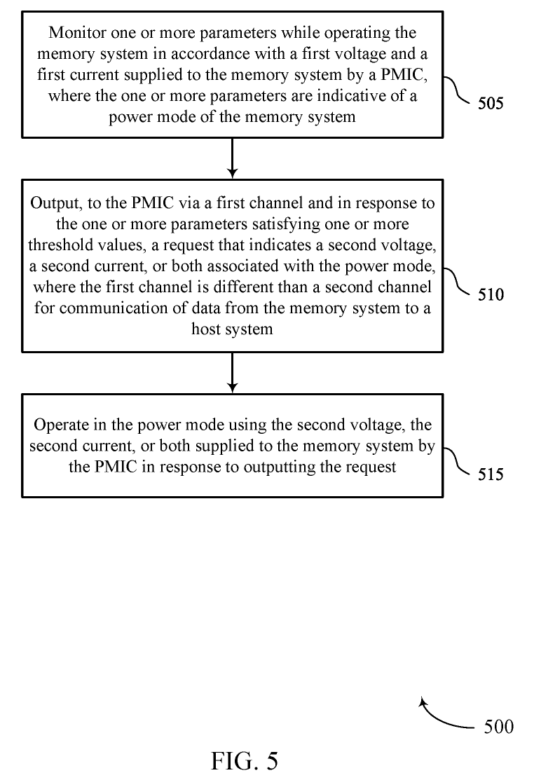

FIG. 5 shows a flowchart illustrating a method 500 that supports communication of power parameters between a PMIC and a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include monitoring one or more parameters while operating the memory system in accordance with a first voltage and a first current supplied to the memory system by a power management circuit, where the one or more parameters are indicative of a power mode of the memory system. In some examples, aspects of the operations of 505 may be performed by a parameter monitor component 425 as described with reference to FIG. 4.

At 510, the method may include outputting, to the power management circuit via a first channel and in response to the one or more parameters satisfying one or more threshold values, a request that indicates a second voltage, a second current, or both associated with the power mode, where the first channel is different than a second channel for communication of data from the memory system to a host system. In some examples, aspects of the operations of 510 may be performed by a power request component 430 as described with reference to FIG. 4.

At 515, the method may include operating in the power mode using the second voltage, the second current, or both supplied to the memory system by the power management circuit in response to outputting the request. In some examples, aspects of the operations of 515 may be performed by a power mode operation component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for monitoring one or more parameters while operating the memory system in accordance with a first voltage and a first current supplied to the memory system by a power management circuit, where the one or more parameters are indicative of a power mode of the memory system; outputting, to the power management circuit via a first channel and in response to the one or more parameters satisfying one or more threshold values, a request that indicates a second voltage, a second current, or both associated with the power mode, where the first channel is different than a second channel for communication of data from the memory system to a host system; and operating in the power mode using the second voltage, the second current, or both supplied to the memory system by the power management circuit in response to outputting the request.

Aspect 2: The method, apparatus, or non-transitory computer-readable medium of aspect 1, further including operations, features, circuitry, logic, means, or instructions, or any combination thereof for receiving a confirmation message that indicates an output voltage, an output current, or both, supplied by the power management circuit is adjusted in response to the request, where the memory system operates in the power mode using the second voltage, the second current, or both further in response to the confirmation message.

Aspect 3: The method, apparatus, or non-transitory computer-readable medium of aspect 2, where the confirmation message is in accordance with the request and one or more operational parameters associated with the host system.

Aspect 4: The method, apparatus, or non-transitory computer-readable medium of any of aspects 1 through 3, further including operations, features, circuitry, logic, means, or instructions, or any combination thereof for receiving a query associated with the power management circuit, where the request that indicates the second voltage, the second current, or both is output further in response to the query.

Aspect 5: The method, apparatus, or non-transitory computer-readable medium of any of aspects 1 through 4, where the one or more parameters include a temperature parameter associated with the memory system, a data transfer rate parameter associated with the memory system, a current draw parameter associated with the memory system, a low power mode parameter associated with the memory system, or any combination thereof.

Aspect 6: The method, apparatus, or non-transitory computer-readable medium of any of aspects 1 through 5, where operating in the power mode using the second voltage, the second current, or both includes operations, features, circuitry, logic, means, or instructions, or any combination thereof for operating in accordance with a dynamic voltage scale mode, a pulse width modulation mode, a phase frequency modulation mode, or any combination thereof in accordance with the request indicating the second voltage, the second current, or both.

Aspect 7: The method, apparatus, or non-transitory computer-readable medium of any of aspects 1 through 6, where operating in the power mode using the second voltage, the second current, or both includes operations, features, circuitry, logic, means, or instructions, or any combination thereof for switching a state of one or more regulators of the memory system in accordance with the second voltage, the second current, or both.

Aspect 8: The method, apparatus, or non-transitory computer-readable medium of any of aspects 1 through 7, where operating in the power mode using the second voltage, the second current, or both includes operations, features, circuitry, logic, means, or instructions, or any combination thereof for adjusting a type of operation performed at the memory system in accordance with the second voltage, the second current, or both.

Aspect 9: The method, apparatus, or non-transitory computer-readable medium of any of aspects 1 through 8, where operating in the power mode using the second voltage, the second current, or both includes operations, features, circuitry, logic, means, or instructions, or any combination thereof for switching a timing for performance of one or more operations at the memory system in accordance with the second voltage, the second current, or both.

Aspect 10: The method, apparatus, or non-transitory computer-readable medium of any of aspects 1 through 9, where the first channel includes one or more pins associated with outputting the request that indicates the second voltage, the second current, or both and the second channel includes a physical layer channel.

Aspect 11: The method, apparatus, or non-transitory computer-readable medium of aspect 10, where outputting the request that indicates the second voltage, the second current, or both includes operations, features, circuitry, logic, means, or instructions, or any combination thereof for setting the one or more pins to a first value that indicates the second voltage, the second current, or both.

Aspect 12: The method, apparatus, or non-transitory computer-readable medium of any of aspects 1 through 9, where the first channel includes an inter-integrated circuit communication channel between the memory system and the power management circuit and the second channel includes a physical layer channel.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system for memory operations, comprising:
one or more memory devices; and
processing circuitry coupled with the one or more memory devices and configured to cause the memory system to:
monitor one or more parameters while operating the memory system in accordance with a first voltage and a first current supplied to the memory system by a power management circuit, wherein the one or more parameters are indicative of a power mode of the memory system;
output, to the power management circuit via a first channel and in response to the one or more parameters satisfying one or more threshold values, a request that indicates a second voltage, a second current, or both associated with the power mode, wherein the first channel is different than a second channel for communication of data from the memory system to a host system; and
operate in the power mode using the second voltage, the second current, or both supplied to the memory system by the power management circuit in response to outputting the request.

2. The memory system of claim 1, wherein the processing circuitry is further configured to cause the memory system to:
receive a confirmation message that indicates an output voltage, an output current, or both, supplied by the power management circuit is adjusted in response to the request, wherein the memory system operates in the power mode using the second voltage, the second current, or both further in response to the confirmation message.

3. The memory system of claim 2, wherein the confirmation message is in accordance with the request and one or more operational parameters associated with the host system.

4. The memory system of claim 1, wherein the processing circuitry is further configured to cause the memory system to:
receive a query associated with the power management circuit, wherein the request that indicates the second voltage, the second current, or both is output further in response to the query.

5. The memory system of claim 1, wherein the one or more parameters comprise a temperature parameter associated with the memory system, a data transfer rate parameter associated with the memory system, a current draw parameter associated with the memory system, a low power mode parameter associated with the memory system, or any combination thereof.

6. The memory system of claim 1, wherein operating in the power mode using the second voltage, the second current, or both comprises the processing circuitry configured to cause the memory system to:
operate in accordance with a dynamic voltage scale mode, a pulse width modulation mode, a phase frequency modulation mode, or any combination thereof in accordance with the request indicating the second voltage, the second current, or both.

7. The memory system of claim 1, wherein operating in the power mode using the second voltage, the second current, or both comprises the processing circuitry configured to cause the memory system to:
switch a state of one or more regulators of the memory system in accordance with the second voltage, the second current, or both.

8. The memory system of claim 1, wherein operating in the power mode using the second voltage, the second current, or both comprises the processing circuitry configured to cause the memory system to:
adjust a type of operation performed at the memory system in accordance with the second voltage, the second current, or both.

9. The memory system of claim 1, wherein operating in the power mode using the second voltage, the second current, or both comprises the processing circuitry configured to cause the memory system to:
switch a timing for performance of one or more operations at the memory system in accordance with the second voltage, the second current, or both.

10. The memory system of claim 1, wherein:
the first channel comprises one or more pins associated with outputting the request that indicates the second voltage, the second current, or both, and
the second channel comprises a physical layer channel.

11. The memory system of claim 10, wherein outputting the request that indicates the second voltage, the second current, or both comprises the processing circuitry configured to cause the memory system to:
set the one or more pins to a first value that indicates the second voltage, the second current, or both.

12. The memory system of claim 1, wherein:
the first channel comprises an inter-integrated circuit communication channel between the memory system and the power management circuit, and
the second channel comprises a physical layer channel.

13. A non-transitory computer-readable medium storing code comprising instructions which, when executed by processing circuitry of a memory system, cause the memory system to:
monitor one or more parameters while operating the memory system in accordance with a first voltage and a first current supplied to the memory system by a power management circuit, wherein the one or more parameters are indicative of a power mode of the memory system;
output, to the power management circuit via a first channel and in response to the one or more parameters satisfying one or more threshold values, a request that indicates a second voltage, a second current, or both associated with the power mode, wherein the first channel is different than a second channel for communication of data from the memory system to a host system; and
operate in the power mode using the second voltage, the second current, or both supplied to the memory system by the power management circuit in response to outputting the request.

14. The non-transitory computer-readable medium of claim 13, wherein the instructions, when executed by the processing circuitry of the memory system, further cause the memory system to:
receive a confirmation message that indicates an output voltage, an output current, or both, supplied by the power management circuit is adjusted in response to the request, wherein the memory system operates in the power mode using the second voltage, the second current, or both further in response to the confirmation message.

15. The non-transitory computer-readable medium of claim 14, wherein the confirmation message is in accordance with the request and one or more operational parameters associated with the host system.

16. The non-transitory computer-readable medium of claim 13, wherein the instructions, when executed by the processing circuitry of the memory system, further cause the memory system to:
receive a query associated with the power management circuit, wherein the request that indicates the second voltage, the second current, or both is output further in response to the query.

17. The non-transitory computer-readable medium of claim 13, wherein the one or more parameters comprise a temperature parameter associated with the memory system, a data transfer rate parameter associated with the memory system, a current draw parameter associated with the memory system, a low power mode parameter associated with the memory system, or any combination thereof.

18. The non-transitory computer-readable medium of claim 13, wherein the instructions to operate in the power mode using the second voltage, the second current, or both, when executed by processing circuitry of a memory system, cause the memory system to:
operate in accordance with a dynamic voltage scale mode, a pulse width modulation mode, a phase frequency modulation mode, or any combination thereof in accordance with the request indicating the second voltage, the second current, or both.

19. The non-transitory computer-readable medium of claim 13, wherein the instructions to operate in the power mode using the second voltage, the second current, or both, when executed by processing circuitry of a memory system, cause the memory system to:
switch a state of one or more regulators of the memory system in accordance with the second voltage, the second current, or both.

20. The non-transitory computer-readable medium of claim 13, wherein the instructions to operate in the power mode using the second voltage, the second current, or both, when executed by processing circuitry of a memory system, cause the memory system to:
adjust a type of operation performed at the memory system in accordance with the second voltage, the second current, or both.

21. The non-transitory computer-readable medium of claim 13, wherein the instructions to operate in the power mode using the second voltage, the second current, or both, when executed by processing circuitry of a memory system, cause the memory system to:
switch a timing for performance of one or more operations at the memory system in accordance with the second voltage, the second current, or both.

22. A method for memory operations at a memory system, comprising:
monitoring one or more parameters while operating the memory system in accordance with a first voltage and a first current supplied to the memory system by a power management circuit, wherein the one or more parameters are indicative of a power mode of the memory system;
outputting, to the power management circuit via a first channel and in response to the one or more parameters satisfying one or more threshold values, a request that indicates a second voltage, a second current, or both associated with the power mode, wherein the first channel is different than a second channel for communication of data from the memory system to a host system; and
operating in the power mode using the second voltage, the second current, or both supplied to the memory system by the power management circuit in response to outputting the request.
